(19) United States
(12) Patent Application Publication
(10) Pub. No.: US 2010/0221166 A1
(43) Pub. Date: Sep. 2, 2010

(54) Photocatalytic Fluidized Bed Air Purifier

(76) Inventor: Darrin S. Muggli, Grand Forks, ND (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/086,960

(22) PCT Filed: Dec. 26, 2006
(86) PCT No.: PCT/US2006/049282

§ 371 Date: Jun. 23, 2008

Related U.S. Application Data
(60) Provisional application No. 60/597,907, filed on Dec. 23, 2005.

(51) Int. Cl. B01D 53/72; B01D 53/38; B01J 19/08; B01J 21/04; B01J 23/50; B01J 21/06

(52) U.S. Cl. 423/245.1; 423/210; 422/186.3; 502/351; 502/348

(57) ABSTRACT

A device and method thereof for the indoor-air purification that utilizes photocatalytic oxidation and ultraviolet lights in a fluidized bed to remove pollutants. The fluidized bed contains ultraviolet lights that are immersed within the bed for direct access to ultraviolet-irradiation. Fluidization aids such as vibration and static mixers may be employed to allow for better circulation of the catalyst bed to increase reaction rates. Photocatalytic oxidation within the device uses photocatalyst particles that were designed to be more active, fluidize better and have ten-fold higher attrition-resistant qualities than current industry standards. The device provides for the most efficient use of and longevity of ultraviolet light which reduces operating costs.

### BACKGROUND OF THE INVENTION

Conventional technology is effective at removing particles from the air, but to a far lesser extent breaking down air contaminants such as odors. To date, air purifiers have used a variety of filters, including electrostatic and HEPA, to remove particles from the air (U.S. Pat. Nos. 4,750,917; 5,225,167). In other air purifiers, the air is sterilized using ultra-violet irradiation (U.S. Pat. No. 6,730,265). In yet other air purifying devices, contaminants are captured on solid support that contains a catalyst and in some cases absorbent material, such as carbon, and subsequently photocatalytically treated with ultra-violet irradiation (U.S. Pat. Nos. 4,954,465; 5,035,784; 6,558,639; 5,919,422; 6,558,639; 5,919,422; 5,032,241; 5,835,840; 6,051,194; and U.S. Pat. App. Pub. No. 2004/0007453).

Other undesirable air pollutants such as volatile organic compounds and microorganisms have contributed to the growing concerns about the health effects caused from indoor air pollution. Photocatalytic oxidation has been shown to oxidize effectively a wide variety of gas-phase volatile organic compounds at room temperature as well as kill microorganisms. However, because of their design, existing devices in the marketplace are able to remove or breakdown only limited amounts of volatile organic compounds and microorganisms. Two primary flaws of current devices are the limited amount of catalyst surface area and accessibility to a photocatalytic light source. Specifically, an effective photocatalytic oxidation reactor must irradiate efficiently the catalyst with ultraviolet light while achieving good contact between reactants and catalyst. The packed-bed reactor is not suitable for photocatalytic oxidation because light cannot penetrate into the interior of the bed. Thin-film reactors, which comprise the majority of the state-of-the-art reactor designs, use catalyst efficiently but may present diffusion limitation problems and their low catalyst loadings reduce adsorption capacities. This can be especially detrimental for indoor-air applications where organics at low concentrations adsorb to concentrate and then react, requiring more catalyst to increase adsorption capacities.

In general, it is known that fluidized bed reactors provide good mixing of reactant and catalyst, however due to particle composition limitations little work has been performed on developing a commercial air purifier using a fluidized bed and ultraviolet sources. When searching for an appropriate photocatalyst, the best commercial choice is the current standard for photocatalytic oxidation, Degussa P-25 TiO₂. For fluidized bed applications, the small particle size of Degussa-P-25 renders it unsuitable for commercial applications. Because particles are smaller than approximately 30 μm (classified as Geldart-C particles), the strong cohesion forces cause particle agglomeration, channeling of gas, and minimum fluidization velocities than predicted. Moreover, strong interparticle forces of Geldart-C powders lead to slugging and formation of agglomerates. Another serious limitation with fluidization processes is elutriation of particles, which causes the rapid loss of catalyst and downstream line blockage. P-25 was found to have unacceptably high rate of catalyst elutriation, with more than 10% of the catalyst lost during the first 5 hours of use.

The proposed invention unexpectedly resolves the key problems of the current air purifiers by utilizing a fluidized bed photoreactor that will be more efficient in photocatalysis of air contaminants by utilizing a novel design and unique catalyst particles. The TiO₂—Al₂O₃ catalyst synthesized for the photoreactor will possess particle sizes in the Geldart-A range to improve fluidization. In addition, because TiO₂ is coated on an Al₂O₃ support, it is more attrition resistant so that catalyst losses will be minimal. Surprisingly, in addition to being more attrition resistant, the TiO₂/Al₂O₃ catalyst is also more active than TiO₂ alone or Degussa P-25 TiO₂. The new air purifier offers several advantages of being more effective in removing contaminants, more efficient in their removal and able to extend the life of the photocatalytic light source.

### BRIEF SUMMARY OF THE INVENTION

The present invention relates to a method for the effective reduction of pollutants from the air using a photocatalytic fluidized bed with ultraviolet lights embedded within the fluidizing chamber. In the preferred invention the ultraviolet light source is used intermittently after adsorption of air contaminants on the surface of the catalyst material. Additional ultraviolet lights may be placed on the outside of the fluidizing chamber. The intermittent use of the ultraviolet light source extends its life and reduces the cost of operation.

In another aspect of the present invention is a device that reduces the concentration of one or more air pollutants using one or more photocatalysts and a source to provide ultraviolet or near-ultraviolet irradiation. The air pollutants may include volatile organic compounds, microscopic organisms, and other undesirable air contaminants.

The device contains a reactor containing a distributor plate to hold the catalyst particles and disperse gas evenly, a means where the lights to be submersed in the catalyst bed, and an optional controls to permit the lights to be turned on and off during adsorption and photocatalysis mode. A vibration source can be used to fluidize the catalyst particles. Vibration sources may be a fan, vibration mixer or static mixer. The process for reducing pollutant concentration consists of feeding the contaminated gas into the air inlet, where said device would allow the gas to flow through the distributor plate into the catalyst bed and the removal of contaminants occurs both by adsorption onto catalyst particles and photoreaction on the catalyst surface (or in the gas phase). Preferred ultraviolet light sources are black lights, fluorescent bulbs, and Hg-arc lamps. The adsorption and photoreaction processes can occur simultaneously or consecutively during operation.

In the preferred invention described herein, a method was used to produce coated catalyst particles that are particularly desired in fluidized bed reactor. Coated catalyst particles exhibit unique properties that enable a commercial photocatalytic fluidize bed reactor device. The coated catalyst particles have increased resistant to attrition and the appropriate size to be retained under the fluidization process. The method was further useful in providing properties to the coated catalyst particles with increased catalyst activity in oxidizing air contaminants. The preferred coated catalyst particles were prepared using a catalyst, preferably TiO₂, and a metal oxide support. A variety of metal oxide support materials included CeO, MgO, and SiO₂ and more preferably, Al₂O₃. Addition of 0.1% to 5.0% Pt, Pd, Ag, and Au, further enhanced the desired properties of the coated catalyst particles.

### BRIEF DESCRIPTION OF THE DRAWINGS

FIG. 1 is a schematic view of a fluidized bed photoreactor according to the present invention.

FIG. 2 is a graph of experimental data for varied calcination temperature and measured catalyst activity.

FIG. 3 is a graph of particle size distribution for TiO₂/Al₂O₃ particles.

FIG. 4 is a graph of particle size distribution for P-25 particles after grinding.

### DETAILED DESCRIPTION OF INVENTION

In the present invention an improved device is described wherein a photocatalytic fluidized bed immersed in an enclosure such as a cylinder around a source of ultraviolet lights that efficiently and effectively removes pollutants from air, including organics and microscopic organisms, using unique photocatalytic particles with enhanced attrition properties. Unexpectedly, the device increased the longevity of the ultraviolet light sources, improves air purity including low concentrations of pollutants, and reduces operating costs.

The device includes catalyst particles contained within an enclosure, which may include a variety of shapes, most preferably of which is a tube or cylindrical shape. In the best mode of the invention, contaminated air flows upward inside of the enclosure at a velocity such that the catalyst particles move, or fluidize, however the velocity is less than that required to push the particles from the container. Sources of irradiation (e.g. lights) of sufficient energy to initiate reactions are placed within the enclosure to provide a means for reactions catalyzed by the particles. One required element of the light source is wavelength that constitutes ultraviolet or near-ultraviolet light. Sources of light may include black lights, fluorescent bulbs, and Hg-arc lamps, most preferably the light source is nearly pure ultraviolet lights. The catalyst particles circulate between regions in the enclosure that are dark and those that are irradiated. This mixing allows all catalyst particles to be irradiated with light, in contrast to packed bed reactors in which the catalyst particles do not move. Ideally, the movements of the particles with the container produce sufficient mixing of the particles in the container that results in placement of a particle near the ultraviolet light source at least once within a period of 10 minutes, preferably less than 5 minutes, and most preferably less than 1 minute. For contaminant species contained in the incoming air to react, they typically must first adsorb onto the catalyst surface. Subsequently, when the surface is exposed to light of the appropriate wavelength, adsorbed species react on the catalyst surface.

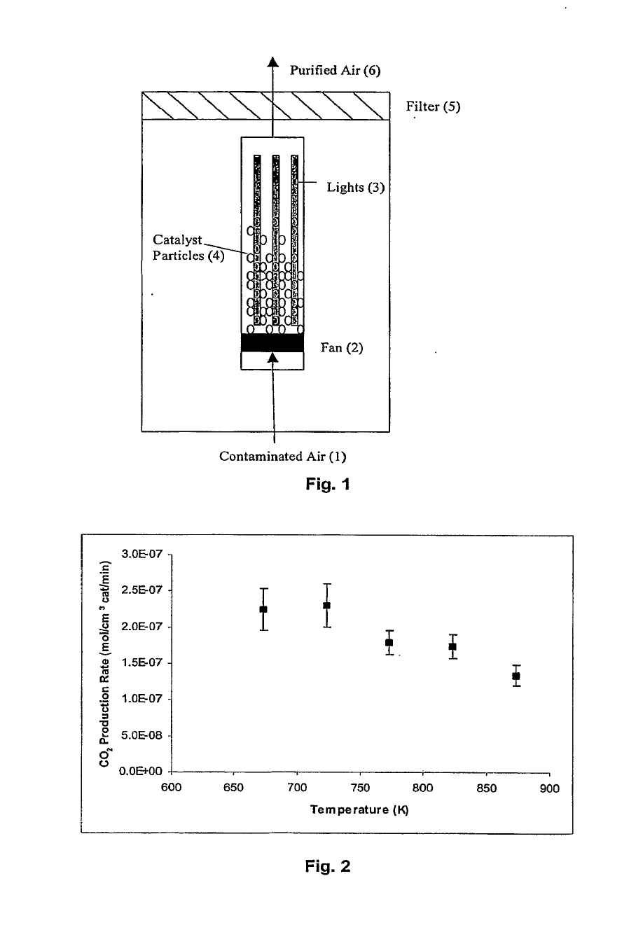

One major advantage of the invention herein is that the light-initiated reaction occurs readily at room temperature unlike other catalytic reactions such as oxidation of VOCs on supported metal catalysts. Thus, no heating of the input fluid is required unlike other inventions where thermocatalysis is a requirement (U.S. Pat. No. 6,582,666). This is particularly advantageous for conditions where heat generation is an undesirable quality or detrimental for use such as for indoor-air applications. Another advantage of the invention is that the fluidized bed design allows for a large amount of catalyst in the enclosure with respect to other devices such as those that use thin films of catalyst for PCO. This is particularly effective for indoor applications in which the target pollutants to be removed are present in the air at low concentrations. A schematic of the basic fluidized bed photoreactor is illustrated in FIG. 1. The contaminated air (1) is pulled through opening in the base of a container using a fan (2) that is mounted at the base of the chamber. It should be noted that in alternative embodiments, the contaminated air (1) can be circulated through the purification device using other means, such as a furnace fan with the device enclosed in the heating/AC ductwork. In the illustrated embodiment, the light sources (3) are oriented in the perpendicular orientation to the fan housing, however other orientations may be more desirable based on the application that permits adequate fluid flow of the photocatalyst particles. The air contaminant is absorbed onto the catalyst particles (4) or “trapped” and the purified air (6) flows through the chamber and passes through an optional filter (5) at the top of the chamber. Unlike current devices which use thin-film reactors with limited surface area the contaminant species are first concentrated on the surface of the particles in the dark. Periodically, the light source can be turned on to initiate the catalyst reaction. The imbedded orientation of the light source together with the fluidized process accelerates the catalytic breakdown of the contaminant. Because the pollutant is concentrated on the catalyst surface, the reaction rates are higher than they would otherwise be. An added benefit means that the lights do not have to be on continuously but may be operated intermittently, which will greatly increase light bulb lifetimes and reduce operating costs.

One of the major drawbacks of fluidized bed reactors in the marketplace is that catalyst particles impact each other as well as with the reactor walls. This causes pieces of the particles to break off, causing a decrease in particle size (attrition). The small catalyst particles (fines) are not heavy enough to remain in the fluidized bed and the up flowing fluid can carry them out of the enclosure. The process of losing catalyst particles is referred to elutriation. The catalyst particles that have escaped the enclosure can cause problems by collecting and plugging downstream, particularly at filtering devices. This is an important factor in limiting the application of photocatalytic fluidized bed reactors. To address this problem, the invention includes a specially developed catalyst particle that is approximately two orders of magnitude more elutriation resistant than the current standard catalyst for photocatalysis. Surprisingly, this elutriation-resistant catalyst is even more active (it catalyzes reactions more quickly) than the current standard catalyst. The catalyst particles consist of TiO₂ or other photocatalytically active metal oxide coated on a support such as Al₂O₃, SiO₂, and like materials. The resulting particle is approximately 1% to 50% by weight TiO₂ or other photocatalytically active material, more preferably between 20% to 40%, with the majority of the remaining weight made up by an attrition-resistant support such as, but not limited to, Al₂O₃. To further increase the particle performance, small amounts, ranging from 0.1 to 5.0 weight percent, of metals may be added to the particles. Such metals include, but not limited to, Ag, Au, Pd, and Pt.

Another unique aspect of the proposed invention is that the lights will be placed inside of the fluidized bed, rather than surrounding it as in most photoreactor designs. Placing the lights in the bed will maximize the use of light, as less will be lost due to reflection and scattering. That is, nearly every photon of light emitted by the lamp will reach a catalyst particle and thus be available to initiate reactions. In contrast, typical photoreactors have lights placed around a glass enclosure. Some of the light reflects off of the surface and is lost and other photons are absorbed by the glass (or other enclosure material). In addition to being placed within the fluidized bed, if desired light sources may be placed on the outside if needed to increase the photoreactor capability.

### Example 1

### Production of Catalyst Particles Designed for Fluidized Bed

Samples of Degussa P-25 (50-m²/g; 70% anatase, 30% rutile) were provided by the Degussa Corporation (NJ, USA). TiO₂/Al₂O₃ catalyst was prepared by mixing the appropriate amount of ethanol (95% vol.) and γ-alumina (Aldrich, Brockmann I, Standard Grade) to achieve the desired TiO₂ loading. Table 1 shows various ratios of TiO₂ and Al₂O₃ tested, but other ratios may be used. The catalyst activity for each of the catalysts is shown as the CO₂ production rate in Table 2. Titanium (IV) butoxide (Aldrich, 97%) was added slowly to the mixture and the solution was heated to 353 K until the liquid was completely evaporated. The resulting solid was dried at 423 K for an additional 4 hours and finally calcined, which is heating in the presence of O₂, at the desired temperature for 4 hours. FIG. 2 shows experiments that varied calcination temperature and measured catalyst activity; other calcination temperatures may be used in an effort to improve catalyst performance (2:1 TiO₂—Al₂O₃). Particles containing only TiO₂, denoted p-TiO₂, were prepared similarly, in the absence of γ-alumina

TABLE 1
Ti:Al ratios TiO₂—Al₂O₃ Catalysts

| TiO₂ wt % | Titanium Butoxide (ml) | Ethanol (ml) | Al₂O₃ (g) |
|---|---|---|---|
| 10 | 25 | 75 | 50.0 |
| 20 | 50 | 150 | 50.0 |
| 30 | 100 | 300 | 50.0 |
| 40 | 150 | 450 | 50.0 |
| 50 | 200 | 600 | 50.0 |

TABLE 2
CO₂ Production Rates for TiO₂—Al₂O₃ Catalysts Calcined.

| | | Coverage, □ |
|---|---|---|
| | CO₂ production rate × 10⁷ | (μmol/g- |
| TiO₂ wt % | (mol/cm³ cat-min) | catalyst) |
| 10 | 1.1 +/− 0.22 | 290 +/− 66 |
| 20 | 1.2 +/− 0.31 | 290 +/− 53 |
| 30 | 2.3 +/− 0.30 | 330 +/− 19 |
| 40 | 0.88 +/− 0.11 | 230 +/− 88 |
| 50 | 0.55 +/− 0.04 | 230 +/− 66 |

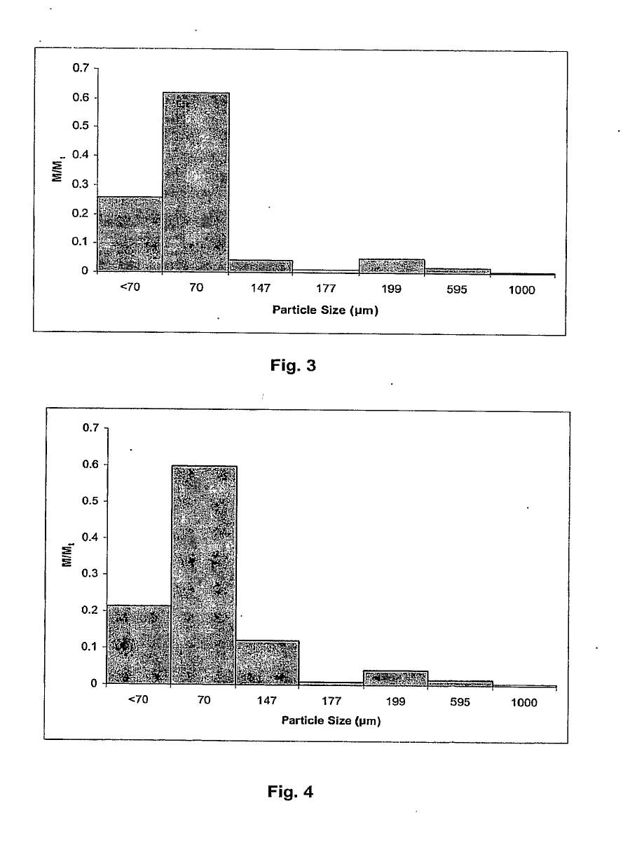

After the particles were prepared, Tyler sieve analysis was used to determine the particle-size and size distributions for both TiO₂/Al₂O₃ and p-TiO₂ particles. It was observed that the particle sizes for TiO₂/Al₂O₃ ranged in size as shown in FIG. 3, based on mass distributions obtained from Tyler mesh analysis performed on 30 g of TiO₂—Al₂O₃. In contrast, the particle sizes were significantly larger than those of P-25, which have an average size of 25 μm. In order to compare the effectiveness of particles, the p-TiO₂ particles were ground using mortar and pestle to the particle-size distribution of TiO₂/Al₂O₃ (FIG. 4). Mass distributions obtained from Tyler mesh analysis performed on 28.5 g of p-TiO₂. This allowed for a direct comparison of the oxidative activities of the two catalysts under similar fluidization conditions. In general, it was desired that the optimal size of particles for fluidized bed applications under the conditions used ranged from 20 to 200 μm, more preferably from 30 to 100 μm and most preferably from 50 to 90 μm.

### Example 2

### Photocatalytic Oxidation of Organics using Catalyst Particles

Methanol (MeOH) is a common indoor-air pollutant that has a high photoefficiency, which makes photocatalytic oxidation an attractive method for its removal. Experiments investigated methanol photocatalytic oxidation in fluidized beds using Geldart-C particles, Degussa P-25 TiO₂, and two Geldart-A catalysts: TiO₂ prepared as described herein using a precipitation method (denoted p-TiO₂), and TiO₂/Al₂O₃. A comparison of the two Geldart-A catalysts allowed for the determination of the effect of Al₂O₃ as a support.

A series of experiments were performed in a 2-cm diameter fluidized bed to measure the elutriation rate and CO₂ production rates during photocatalytic oxidation of methanol to determine the activities of test catalysts in fluidized beds. Table 3 shows the average CO₂ production rates during photocatalytic oxidation and the percent of the catalyst bed elutriated during the experiment over a period of 4.5 hours. The CO₂ production rates were evaluated under fluidizing and non-fluidizing (packed) conditions. For these experiments, and in contrast to the invention, the UV lights were located outside of the catalyst bed, because of the small diameter of the bed used.

It was demonstrated TiO₂/Al₂O₃ consistently produced the highest CO₂ production rate, followed by P-25 (the current standard) and p-TiO₂ under fluidizing conditions. Further, paired t-statistic tests indicated, with greater than 99% confidence, that TiO₂/Al₂O₃ was more active than P-25 in both fluidized and packed beds. This result is surprising in that the Al₂O₃ support is inactive for photocatalysis. Unexpectedly, when TiO₂ is deposited on Al₂O₃, the TiO₂/Al₂O₃ was more than twice, 2.32 fold, the activity of pure TiO₂ made by the same method under a fluidized state (Table 3). Because the particle-size distribution was nearly the same for TiO₂/Al₂O₃ and p-TiO₂, catalyst activity caused the differences in their CO₂ production rates rather than a difference in fluidization.

The p-TiO₂ catalyst fluidized well, but its inherent catalytic activity was significantly lower than the other catalysts tested; the CO₂ production rate for a fluidized bed of p-TiO₂ was less than that for fluidized P-25 (Table 3). In comparison to the standard, P-25, in the non-fluidized state, TiO₂/Al₂O₃ was 15% more active than P-25. In the fluidized state, the performance of TiO₂/Al₂O₃ increased by 73% relative to P-25. TiO₂/Al₂O₃ and p-TiO₂ are Geldart group A powders with weak interparticle forces acting within the bed, while P-25 is a Geldart group C powder with strong cohesive forces and marginal fluidization properties. Because of marginal fluidization, and the lower intrinsic activity, P-25 is less suitable than TiO₂/Al₂O₃ for fluidized-bed PCO of MeOH. The combination of TiO₂/Al₂O₃ properties accounts for the unexpected increase in its performance for CO₂ production rates and its superior use for photocatalytic oxidation of organic contaminants.

Compared to packed bed operation, fluidization increased CO₂ production rates of P-25 by 26% and TiO₂/Al₂O₃ by 90%. Because the UV lights irradiated only the external surface of the bed, methanol must be transported to the outer region of the bed to resupply catalyst sites. Apparently, transport of methanol to this region limited the CO₂ production rate. Fluidization increased the rate of transport to the UV-irradiation region, which increased reaction rate and therefore improved quantum yield. Note that the current invention differs from this experimental setup in that UV lights can be located either outside or inside of the catalyst bed (or at both locations).

TABLE 3
CO₂ Production Rates for Catalysts under Fluidizing and Non-
Fluidizing Conditions.

| | | CO₂ production rate × | |
|---|---|---|---|
| | | 10⁷ | Ratio Relative |
| Catalyst | Fluidization | (mol/cm³ cat/min) | to P-25 |
| Degussa P- | Yes | 1.1 +/− 0.015 | 1.00 |
| 25 | No | 0.87 +/− 0.027 | 1.00 |
| TiO₂—Al₂O₃ | Yes | 1.9 +/− 0.16 | 1.73 |
| | No | 1.0 +/− 0.31 | 1.15 |
| p-TiO₂ | Yes | 0.82 +/− 0.21 | 0.94 |

### Example 3

### Comparison of Catalyst Elutriation Rates under Fluidization

In addition to differences observed for CO₂ production rate, P-25, TiO₂/Al₂O₃ and p-TiO₂ catalysts were examined for their rate of particle breakdown, elutriation, which will dramatically impact the longevity of the fluidized bed material. This is a severe limitation for the commercialization of fluidized bed material in these applications. In Table 4, TiO₂/Al₂O₃ elutriated at rates that were demonstrated to be about 25 fold lower than P-25. TiO₂/Al₂O₃ granular powders were found to have larger average particle sizes, 80 μm, than the average particle size of P-25 at about 30 μm. TiO₂/Al₂O₃ elutriation rates out performed p-TiO₂ as well although both had similar particle sizes, 86 μm for p-TiO₂. Because gas velocity was the same for all catalysts, an added benefit of the larger size of TiO₂/Al₂O₃ and p-TiO₂ decreased the likelihood that particles would become entrained in the gas when compared to P-25.

TABLE 4
Catalyst Elutriation Rates during Fluidization

| | % Catalyst Lost | Ratio Relative |
|---|---|---|
| Catalyst | (g-elutriated/g-initial) | to P-25 |
| Degussa P-25 | 11% +/− 2.4% | 25 |
| TiO₂—Al₂O₃ | 0.44% +/− 0.071% | 1 |
| p-TiO₂ | 0.58% +/− 0.030% | 19 |

The increased resistance to elutriation of the TiO₂/Al₂O₃ catalyst is significant in that the high elutriation rate of TiO₂-based fluidized bed photoreactors has made them commercially impractical. The invention described herein solves two major limitations in the commercialization of fluidized-bed photocatalytic reactors, catalyst breakdown and increased CO₂ production rates.

### Example 4

### Photocatalytic Oxidation of Bacteria

Because the catalyst contains significant amounts of photocatalytically active material, the present invention is effective in removing microorganisms, spores, and material associated with biofilms from both gas and liquid phases. These materials arrive at the catalyst surface from the gas phase either directly or via aerosols. In the invention described herein, the high oxidation state coupled with ultraviolet illuminations is effective in killing a variety of microorganisms to include bacteria, fungi and viruses, including various cellular components such as metabolites, proteins, lipids, nucleic acid and the like. As an example such biologicals includes, but is not limited to, pathogenic Escherichia coli, Micrococcus luteus, Bacillus subtilis, Aspergillus niger spores, phosphatidylethanolamine, flu viruses, bovine serum albumin, and gum xanthan.

### Example 5

### Modification of Catalysts

The catalyst can be modified by adding dopants to increase performance. Dopants include, but are not limited to, Pt, Pd, Ag, Au, Fe, MgO, and CeO. This example showed the development of an improved photocatalyst to increase the efficiency of the invention. To this end, a detailed study of the effects of depositing a small amount of an inexpensive metal, silver (Ag), on TiO₂/Al₂O₃ was conducted.

Two TiO₂—Al₂O₃ catalysts were produced: TiO₂ (30 wt %)—Al₂O₃ using a procedure from Liu et al. (1), and TiO₂ (50 wt %)-Al₂O₃ using a procedure from Chen et al. (Liu et al, Applied Catalysis A: General, 239, 1-2, (2003); Chen et al, J Photochem Photobi A: Chemistry, 170, 1, (2005)). A four-factor full factorial experimental design with center points was intended to determine the effects of the initial pH of the photodeposition solution, the initial CH₃OH concentration of the photodeposition solution, amount of time allowed for photodeposition, and Ag wt % loading on the photocatalytic activity of TiO₂ (30 wt %)-Al₂O₃. The Ag wt % loadings in this design were based on total catalyst mass, rather than the mass of TiO₂, which caused higher loadings than optimal, resulting in a catalyst activity less than that of TiO₂ (30 wt %)-Al₂O₃ alone. Photodeposition selectively deposits Ag on TiO₂, causing the TiO₂ to be overloaded under the conditions in this experimental design. The levels for the initial pH of the photodeposition solution, and the initial CH₃OH concentration of the photodeposition solution were the same as those used for photodeposition of Ag on Degussa P-25 TiO₂ and sol-gel TiO₂. The amounts of time allowed for photodeposition were 30 minutes, 60 minutes, and 90 minutes. At each condition in the experimental design, the Ag⁺ concentration of the photodeposition solution following photodeposition was zero, proving that time was not an important factor in the photodeposition of Ag on TiO₂ over the range of conditions included in this study. Subsequent experiments allowed 60 minutes for photodeposition, and in each case the Ag⁺ concentration of the photodeposition solution after photodeposition was zero.

Subsequent experiments that adjusted Ag loading based on TiO₂ amount are shown in Table 5. A 1.0 wt % Ag loading on 30% TiO₂—Al₂O₃ and 50% TiO₂—Al₂O₃ increased significantly the catalyst activity. Prior to Ag photodeposition, the activities of 30% TiO₂—Al₂O₃ and 50% TiO₂—Al₂O₃ were equal. With a 1.0 wt % Ag loading on both catalysts, the 50% TiO₂—Al₂O₃ was more substantially more active than the 30% TiO₂—Al₂O₃. The 1.0 wt % Ag loading on 50% TiO₂—Al₂O₃ resulted in a catalyst over 1.5 times more active than 50% TiO₂—Al₂O₃ alone.

TABLE 5
CO₂ Production Rates in the Presence of Dopants.

| | TiO₂(30 wt %)—Al₂O₃^{b} | TiO₂(50 wt %)—Al₂O₃^{c} |
|---|---|---|
| | CO₂ Production Rate × 10⁷ | CO₂ Production Rate × 10⁷ |
| Ag wt %^{d} | (mol/min/g-cat) | (mol/min/g-cat) |
| 0^{a} | 1.7 ± 0.1 | 1.7 ± 0.3 |
| 1.0 | 2.1 ± 0.3 | 2.7 ± 0.4 |

^{a}Represents the catalyst without silver photodeposition
^{b}Prepared using method 1
^{c}Prepared using method 2
^{d}Based on mass of TiO₂

Optimal conditions were determined for obtaining efficient and stable photocatalyst for the use in fluidized-bed photoreactors. The optimum of silver loading of approximately was 1 wt %; higher silver loadings decreased catalyst activity, compared to the respective unloaded catalyst, for both Degussa P-25 TiO₂ and sol-gel TiO₂.

### Other Embodiments

The description of the specific embodiments of the invention is presented for the purpose of illustration. It is not intended to be exhaustive nor to limit the scope of the invention to the specific forms described herein. Although the invention has been described with reference to several embodiments, it will be understood by one of ordinary skill in the art that various modifications can be made without departing from the spirit and the scope of the invention, as set forth in the claims. All patents, patent applications and publications referenced herein are hereby incorporated by reference.

Other embodiments are within the claims.

1. A method for the reducing a contaminant from air using a bed reactor containing catalyst particles, comprising:
a) using a vibration source to fluidize said catalyst particles in said bed reactor;
b) passing said contaminated air through said fluidized bed reactor;
c) allowing contaminant to be absorbed from the air by said catalyst particle;
d) exposing said catalyst particle to a ultraviolet light source to oxidize said contaminant; and
e) passing said oxidized contaminants from said fluidized bed reactor.

2. The method of claim 1, further comprising using a filter to retain said catalyst particles.

3. The method of claim 1, wherein said ultraviolet light source is mounted within said fluidized bed reactor.

4. The method of claim 1, wherein said vibration source is a fan, vibration mixer or static mixer.

5. The method of claim 4, further comprising using additional ultraviolet light source placed on the outside of said fluidized bed reactor.

6. The method of claim 1 and claim 5, wherein said ultraviolet light source is intermittently operated.

7. The method of claim 1, wherein said contaminants are selected from a group consisting of organic chemical material and biological material.

8. The method of claim 4, further comprising not using an external heat source.

9. A device for reducing air contaminant, comprising:
a) a fluidized bed reactor with a vibration source capable of fluidization flow rates;
b) a ultraviolet light source that mounted within said fluidized bed reactor; and
c) particles containing catalysts, wherein said catalyst particles are fluidized within said fluidized bed reactor during operation.

10. The device of claim 9, further comprising said ultraviolet light source is intermittently operated.

11. The device of claim 9, further comprising a vibration source to fluidize said catalyst particles.

12. The device of claim 9, further comprising a non-stick and non-ultraviolet blocking shield around said ultraviolet light source.

13. The device of claim 9, further comprising a filter to retain said catalyst particles.

14. The device of claim 9, further comprising additional ultraviolet light source placed on the outside of said fluidized bed reactor.

15. The device of claim 9 and claim 14, wherein said ultraviolet light source is selected from a group consisting of black lights, fluorescent bulbs, and Hg-arc lamps.

16. The device of claim 9, wherein said filters are capable of being cleaned and catalyst returned to the reactor.

17. The device of claim 9, wherein said vibration source is a fan, vibration mixer or static mixer.

18. The device of claim 9, wherein said catalyst particles is TiO₂.

19. The device of claim 18, wherein said catalyst particles are coated on a metal oxide.

20. The device of claim 19, wherein said metal oxide is selected from a group consisting of Al₂O₃, CeO, MgO, and SiO₂.

21. The device of claim 19, wherein said coated catalyst particles contain small amount of a metal from a group consisting of Pt, Pd, Ag, and Au.

22. A method for the preparation of catalyst coated particles with increased catalyst activity comprising:
a) mixing said catalyst and a metal oxide support; and
b) selecting particles sizes of 20 to 200 micrometer in size for use in a fluidized bed reactor.

23. The method of claim 22, wherein said catalyst is TiO₂.

24. The method of claim 22, wherein said metal oxide support are selected from a group consisting of Al₂O₃, CeO, MgO, and SiO₂.

25. The method of claim 22, wherein said coated catalyst particles contain small amount of a metal from a group consisting of Pt, Pd, Ag, and Au.

26. The device of claim 25, wherein the concentration of said metal ranges from 0.1% to 5.0% of the total weight of said coated catalyst particles.

27. A method for the preparation of catalyst coated particles with resistant to particle attrition comprising:
a) mixing said catalyst and a metal oxide support; and
b) selecting particles sizes of 20 to 200 micrometer in size for use in a fluidized bed reactor.

28. The method of claim 27, wherein said catalyst is TiO₂.

29. The method of claim 27, wherein said metal oxide support are selected from a group consisting of Al₂O₃, CeO, MgO, and SiO₂.

30. The method of claim 27, wherein said coated catalyst particles contain small amount of a metal from a group consisting of Pt, Pd, Ag, and Au.

31. The device of claim 30, wherein the concentration of said metal ranges from 0.1% to 5.0% of the total weight of said coated catalyst particles.
